(19) United States
(12) Patent Application Publication
(10) Pub. No.: US 2003/0172792 A1
(43) Pub. Date: Sep. 18, 2003

(54) Paper cutter and thermal printer

(76) Inventor: Saburo Imai, Chiba-shi (JP)

Correspondence Address: ADAMS & WILKS, 31st Floor, 50 Broadway, New York, NY, 10004, US

(21) Appl. No.: 10/367,128

(22) Filed: Feb. 14, 2003

(30) Foreign Application Priority Data
Mar. 7, 2002 (JP) 2002-062144

(51) Int. Cl. B26D 5/08; B26D 1/00

(52) U.S. Cl. 83/694; 83/614

(57) ABSTRACT

It is to provide a paper cutter which can tear an uncut portion of paper easily and prevent from reeling out the paper from the device even when the uncut portion of the partial cut paper is pulled straightly.

In a paper cutter 20 having a guide 21 for guiding continuous paper and cutting means 24 and 25 for cutting the continuous paper passing through the guide with one portion thereof uncut, the guide 21 is provided with projections 2a and 2b for adding a resistance to the paper by making contact with the paper and bending the paper in a shape of S when the paper is pulled from the outside, and these projections 2a and 2b are respectively formed in a shape having an inclination such that the protruding degree is small on the side of the inlet of the guide 21 and large on the side of the outlet of the guide 21.

### BACKGROUND OF THE INVENTION

1. Field of the Invention

The present invention relates to a cutter for cutting continuous paper with one portion thereof uncut and a thermal printer having the above cutter.

2. Description of the Related Art

There are some cases where a paper cutter for cutting the continuous paper having been printed, with its one portion uncut, is installed in, for example, an order input device and the like for printing out the menu ordered by a customer in a fast food restaurant, a family restaurant, and the like. Hereafter, this cut is referred to as partial cut.

The partial cut is used for various purposes of preventing the full cut paper from falling down into the device inversely from the outlet, aligning several sheets of paper with the contents of orders printed there in a sequence of the orders in a state of being connected by one portion, by supplying the paper without tearing off the uncut portion according to the partial cut when receiving the orders sequentially, and the like.

Generally, the paper appearing from the outlet after partial cut is divided into each one sheet by a user's pulling the paper and tearing off the uncut portion. In case of the partial cut in which an uncut portion of the paper is left on the right side, when a user pulls the paper, holding the left side of the paper, the cut portion of the paper is opened and a force concentrates on the root, thereby making it easy to tear off the uncut portion.

However, when a user pulls the paper straightly holding the side of the uncut portion of the paper, even if the width of the uncut portion is small, a force is dispersed in this portion, and therefore, in some cases, the uncut portion cannot be torn off easily even if a user pulls it strongly. At this time, there is a fear of reeling out the connected paper from the device. When the paper is reeled out, there are such a problem that the space on the top of the paper will be expanded at the next print-out and such a fear that the paper is swayed at a forwarding time.

Generally, a thermal printer for putting the paper between a printing head and a platen, for printing, is provided in a prior stage of the cutter performing the partial cut, and the paper is in a state of being held by the pressure of the printing head and the platen. Therefore, when the paper is pulled in a state of being uncut with a force stronger than this holding force, the paper will be reeled out. Recently, however, the pressure between the printing head and the platen tends to become lower, and therefore, a problem of reeling out the paper by pulling the partial cut paper becomes more and more serious.

### SUMMARY OF THE INVENTION

An object of the invention is to provide a paper cutter and a thermal printer which can tear off the paper easily and prevent from reeling out the paper from the device, even when a user pulls the partial cut paper straightly by the uncut portion.

In order to achieve the above object, the invention provides a paper cutter having a guide for guiding continuous paper and cutting means for cutting the continuous paper passing through the guide with one portion thereof uncut, wherein the guide is provided with resistance adding means for adding a resistance to the continuous paper when a tensile force works on the continuous paper passing through the guide.

According to the means, even if the paper is pulled in a state difficult to tear, the resistance adding means can add a resistance to the paper, thereby tearing off the paper easily. This can prevent from reeling out the paper.

More specifically, the resistance adding means may be provided in a position corresponding to an uncut portion of the continuous paper left behind without being cut by the cutting means. This structure can add a resistance to the uncut portion of the paper efficiently, and by providing the above means only in a peripheral portion for passing the uncut portion, it is possible to prevent from such a disadvantage that the paper clogging (paper jam) occurs because of obstructing the passage of the paper in the guide.

The resistance adding means may be formed by a plurality of projections for bending the continuous paper in contact with the both surfaces of the continuous paper passing through the guide. According to this structure, there is not so much resistance when the paper simply passes through the guide, and only when the paper is pulled and stretched straightly, some resistance can be added to the paper. Further, the above means can be formed at a low cost.

More specifically, the sum of two projections may be provided: one may be provided on one surface of the continuous paper and the other, on the other surface thereof, and the respective projections are formed in a shape having such an inclination that a protruding degree is small on a side of inlet of the guide and large on a side of outlet of the guide. According to this, they don't obstruct the passage of the paper along the guide but they are formed in the optimum structure to obtain a suitable resistance in pulling the paper.

The above paper cutter is useful especially to be adopted to a thermal printer comprising a printing device for printing by putting the continuous paper between a printing head having a plurality of heating elements for dot printing and a platen and forwarding the continuous paper while rotating the platen, and the paper cutter for cutting the continuous paper forwarded from the printing device to the guide.

### BRIEF DESCRIPTION OF THE DRAWINGS

For a more better understanding of the present invention, reference is made of a detailed description to be read in conjunction with the accompanying drawings, in which:

FIG. 1 is a plane view showing a thermal printer according to the embodiment of the invention;

FIG. 2 is a cross section view taken along line D-D by the arrows in FIG. 1;

FIG. 3 is a lateral cross section view for use in describing the state where the paper is pulled;

FIG. 4 is a view showing the embodiment of providing with three projections as the resistance adding means;

FIG. 5 is a schematic view showing the second embodiment of the resistance adding means; and

FIG. 6 is a schematic view showing the third embodiment of the resistance adding means.

### DETAILED DESCRIPTION OF THE PREFERED EMBODIMENT

Hereinafter, embodiments of the present invention will be described with reference to the drawings.

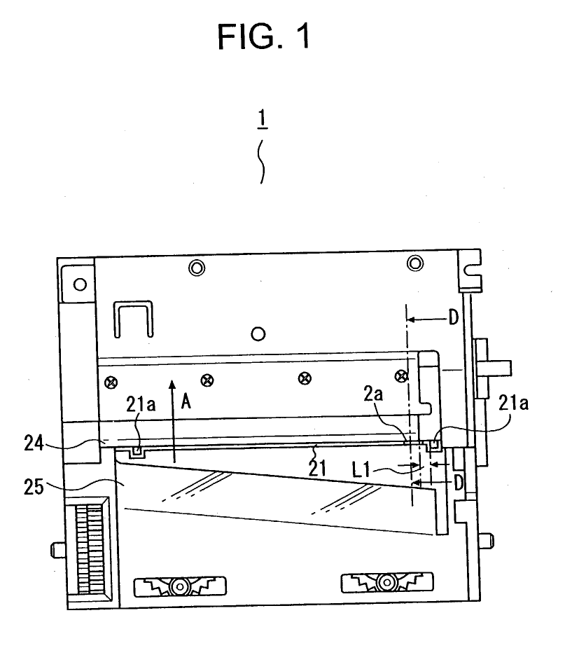

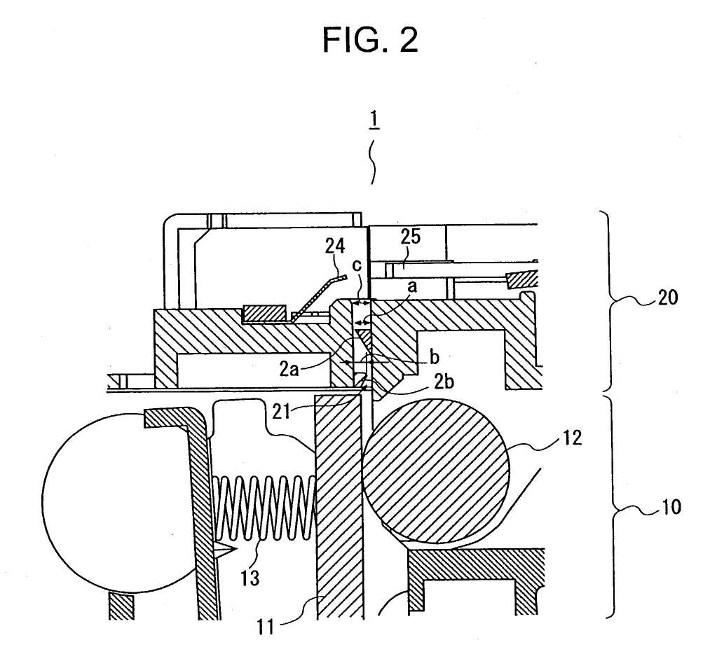

FIG. 1 is a plane view of a thermal printer 1 according to the embodiment of the invention and FIG. 2 is a cross section view taken along line D-D by the arrows in FIG. 1.

The thermal printer 1 of the embodiment is formed by unitizing a printing mechanism 10 for printing on continuous paper such as roll paper and a cutter 20 for partially cutting the continuous paper sent from the printing mechanism 10.

The printing mechanism 10 is to do printing in a state of pushing the continuous paper between a printing head 11 and a platen 12, as illustrated in FIG. 2. On the printing head 11, a plurality of heating elements for dot-printing on the heat sensitive paper are provided in a line direction, so as to do the printing for one line or several lines on the paper by one or several drives. The printing head 11 is being pushed toward the platen 12 by a function of a spring 13 at a constant power. The platen 12 is formed by a member having elasticity so as to make the paper close contact with the portion of the heating elements of the printing head 11, and by rotating the platen 12 intermittently, the paper is forwarded in a forwarding direction (upper portion in FIG. 2) thereby sequentially moving the printing position.

The cutter 20 comprises a guide 21 for introducing the paper discharged from a space between the printing head 11 and the platen 12, to a cutting position, and a fixed blade 24 and a movable blade 25 for clipping and cutting the paper passing through the guide 21. The guide 21 is designed to surround the both surfaces of the paper by its two walls wider than the paper and keep into contact with the both sides of the paper by its right and left convex pieces 21a, 21a so as not to sway the paper. Further, the passage length of the guide 21 is fairly short (for example, 6 to 10 mm). On the way of the guide 21, two projections 2a and 2b are provided as resistance adding means for adding a resistance to the paper when the paper is pulled from the outside.

The movable blade 25 and the fixed blade 24 are respectively as long as the width of the paper or a little longer than that. The movable blade 25 moves back and forth in the direction indicated by the arrow A by the force of a driving motor not illustrated and pinches the paper with the fixed blade 24 so to cut the paper. During printing or while the platen 12 is rotating to forward the paper, the movable blade 25 is waiting at a position not overlapped with the outlet of the guide 21.

The fixed blade 24 is arranged not to overlap the right end portion of the paper passage and thanks to this arrangement, the right end portion of the paper remains as it is without being cut. Namely, the range L1 from the right end portion of the fixed blade 24 to the convex piece 21a on the right side of the guide 21 is served to leave the paper behind as an uncut portion.

Two projections 2a and 2b provided in the guide 21 are provided at a position corresponding to the portion having an uncut portion of the paper left behind in the horizontal direction (direction of the width of the paper), as illustrated in FIG. 1, and respectively at the lowest portion and the middle portion of the guide 21 in the vertical direction, as illustrated in FIG. 2. The projection 2a at the middle stage is provided on one surface of the guide 21 and the projection 2b at the lowest stage 2b is provided on the other surface of the guide 21.

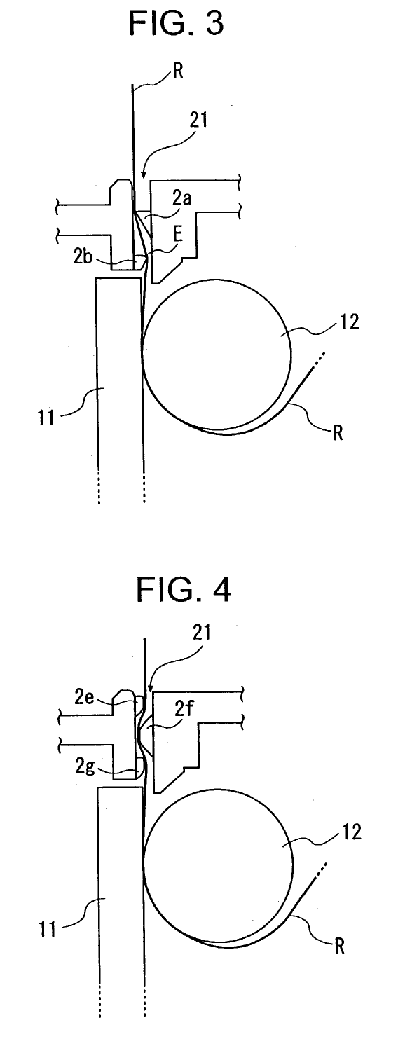

FIG. 3 shows a view from the lateral viewpoint of a state where the paper passing through the guide 21 is pulled from the outside.

These two projections 2a and 2b are designed to have an inclination such that a protruding degree can be small on the side of the inlet of the guide 21 and large on the side of the outlet thereof (inclined about 30° to the wall surface of the guide 21) and that the sum of the maximum protruding degrees a and b of the two projections can be larger than the interstice c of the guide 21 (a+b>c).

The inclination provided in the two projections 2a and 2b makes it easy to pass the paper R when the paper R is forwarded from the printing mechanism 10, and as illustrated in FIG. 3, the passage of the paper is bent, according to the above protruding degree, in a shape of S in a state of tightly stretching the paper R.

Further, in the lower projection 2b, the edge portion E of the maximum protruding degree is cut off like an arc, so that the contact area of this edge portion E and the paper can become larger in a state of pulling the paper R.

According to the above paper cutter 20, the paper is discharged out with the uncut portion left behind in one portion on the right side of the paper, according to the partial cut of the cutter 20. When the paper is straightly pulled by the uncut portion in a state of being discharged, the tightly stretching paper is bent in a shape of S against the two projections 2a and 2b , in the lower portion of the uncut portion of the paper, and a frictional drag is generated in the edge portion of these two projections 2a and 2b.

Namely, the maximum static friction obtained when pulling the paper from the outside is the sum of the static friction f0 in the pressing portion of the platen 12 and the printing head 11 and the static friction (f1+f2) in the edge portions of the two projections 2a and 2b.

Accordingly, even when the paper is pulled in a state incapable of tearing off the uncut portion easily, since the static friction becomes larger compared with the guide without the projections 2a and 2b, it becomes easier to tear off the uncut portion of the paper, and therefore, occurrence of a disadvantage of reeling out the paper from the device can be restrained.

Further, when a tensile force F1 capable of straightly pulling and tearing off the uncut portion of the paper is a little beyond the static friction f0 of the pressing portion of the platen 12 and the printing head 11, the total of the static friction can be larger than the tensile force F1 by adding the static friction of the projections 2a and 2b (f1+f2). Thus, the uncut portion of the paper never fails to be torn off before reeling out the paper.

FIG. 4 shows an example of forming three projections in the guide as resistance adding means.

As the resistance adding means, three projections may be provided in the guide 21, as illustrated in FIG. 4. Namely, they are a projection 2e provided on one surface of the wall in the upper portion, a projection 2f provided on the other surface of the wall in the middle portion, and a projection 2g provided on one surface of the wall in the lower portion. These three projections 2e, 2f, and 2g are formed in a shape of having an inclination such that the protruding degree is small on the inlet side of the guide 21 and that the protruding degree becomes larger and larger according to the direction forwarding to the outlet.

When the maximum protruding degrees of the projections 2e, 2f, and 2g are respectively defined as e, f, and g and the width of the interstice between the both walls of the guide 21 is defined as c, the maximum protruding degrees of the three projections 2e, 2f, and 2g are formed in a way of satisfying the relationship (c<e+f) and (c<f+g). Further, the maximum protruding degree of the upper projection 2e is formed smaller than the lower projection 2g (e<g), so as not to disturb the discharge and the cutting processing of the paper R.

Namely, the lower projection 2g and the middle projection 2f may be formed to have such a protruding degree as to prevent from paper jam (paper clogging) and obtain a desired friction drag, and the upper projection 2e may be formed to have such a protruding degree so as not to cause the paper jam and disturb a cut of the paper. The respective projection 2e to 2g may be formed in any shape as long as they can obtain a desired friction drag and they don't disturb the passage of the paper.

The invention is not restricted to the above embodiments, but various modifications are possible. For example, the following modification can be considered as the resistance adding means for adding a resistance to the paper when the paper is pulled from the outside.

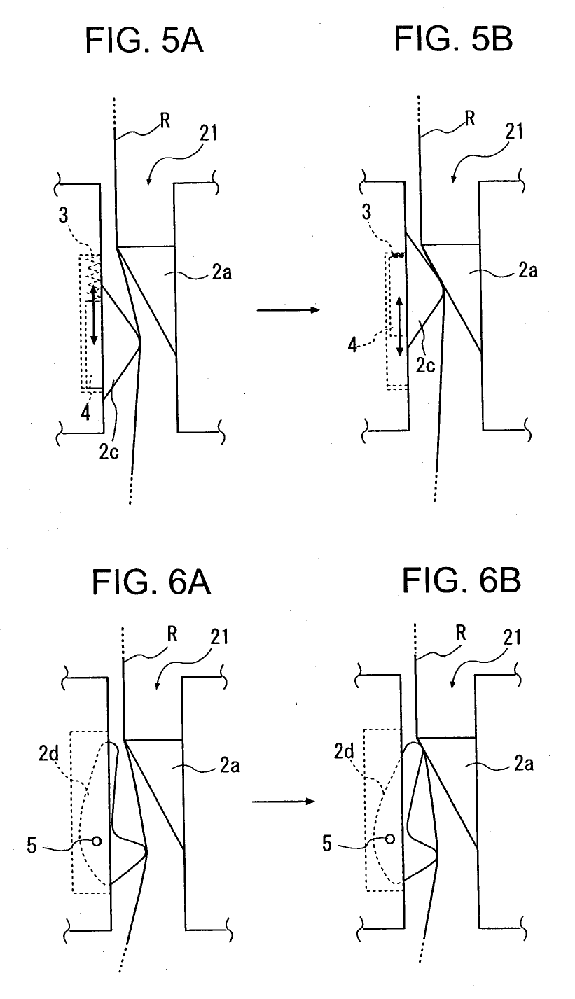

FIG. 5 is a schematic view of the second embodiment of the resistance adding means.

In this embodiment, as the resistance adding means, a movable projection 2c installed in a vertically movable state and a fixedly installed projection 2a are provided on the side walls of the guide 21. When the paper R is forwarded upwardly according to the rotation of the platen 12, the movable projection 2c is positioned at the lower portion by a weak spring force since no strong force works on the paper R, so to pass the paper R through the guide 21. While, when the paper R is strongly pulled from the outside, the paper R comes into close contact with the movable projection 2c, and the movable projection 2c is moved upward by small deformation of the paper R, so to pinch the paper R with the fixed projection 2a. Thus, a strong resistance is added to the paper R. A rubber may be attached to the end portion of the movable projection 2c so as to increase a friction.

A guide groove 3 may be provided on the side wall of the guide 21, in the movable projection 2c, and an engaged portion 4 may be provided on the side portion of the movable projection 2c, hence to engage the engaged portion 4 in the guide groove 3 in a vertically movable way. When a printer at use stands like Fig. 5, since the projection 2c falls down by the own weight, any spring is not necessary.

FIG. 6 shows the schematic view of the third embodiment of the resistance adding means.

In this embodiment, as the resistance adding means, a rotary member 2d rotatable around a supporting point 5 in an elbowed shape and a fixedly installed projection 2d are provided on the side walls of the guide 21. When the paper R is forwarded upwardly according to the rotation of the platen 12, the paper R is moved on a passage which the strong force is not formed on a lower arm of the rotary member 2d, while when the paper R is strongly pulled from the outside, the paper R pushes a lower arm of the rotary member 2d and rotates it until the position of bringing an arm extending upward into contact with the projection 2a. Thus, the paper R is pinched between the upper arm of the rotary member 2d and the fixed projection 2a, thereby adding a strong resistance to the paper R.

Moreover, the resistance adding means may be formed to add a resistance to the paper by pushing the paper by electric drive from the end of the cutting processing to the beginning of the next printing processing, or even in the case of providing with a projection, the shape and the number of the projection is not restricted to the above-mentioned embodiments, but various modification is possible.

In the embodiments, although the description has been made by way of example of the paper cutter of the type of cutting the paper by pinching it between the movable blade moving back and forth and the fixed blade, the invention can be adopted to a cutter of any type including a rotary cutter for cutting the paper while moving a rotary blade along the width direction of the paper and the like.

As set forth hereinabove, according to the invention, the resistance adding means adds a resistance to the paper, which makes it easy to tear off the paper, and therefore, it is effective in preventing from reeling out the paper.

Since the resistance adding means is formed by two projections for bending the passage of the continuous paper while making contact with the both surfaces of the continuous paper and these projections are tapered, nothing obstructs the passage of the paper along the guide and the optimum quality can be obtained such that a proper resistance is added to the paper when pulling the paper.

What is claimed is:

1. A paper cutter comprising:
a guide for guiding continuous paper; and cutting means for cutting the continuous paper passing through the guide with one portion thereof uncut,
wherein the guide is provided with resistance adding means for adding a resistance to the continuous paper when a tensile force works on the continuous paper passing through the guide.

2. A paper cutter according to claim 1, wherein the resistance adding means is provided in a position corresponding to an uncut portion of the continuous paper left behind without being cut by the cutting means.

3. A paper cutter according to claim 1, wherein the resistance adding means is formed by a plurality of projections for bending the continuous paper in contact with the both surfaces of the continuous paper passing through the guide.

4. A paper cutter according to claim 2, wherein the resistance adding means is formed by two projections for bending the continuous paper respectively in contact with the both surfaces of the continuous paper passing through the guide, and these projections are formed in a shape having such an inclination that a protruding degree is small on a side of inlet of the guide and large on a side of outlet of the guide.

5. A thermal printer comprising:
the paper cutter according to one of claims 1 to 4; and
a printing device for printing by putting the continuous paper between a printing head having a plurality of heating elements for dot printing and a platen and forwarding the continuous paper while rotating the platen,
wherein the continuous paper sent from the printing device is forwarded to the guide of the paper cutter so as to be cut.
